(19) United States
(12) Patent Application Publication
(10) Pub. No.: US 2008/0208711 A1
(43) Pub. Date: Aug. 28, 2008

(54) PRINT PRICING

(76) Inventors: Afshin Mirmotahari, Victoria (CA); Noel Burton-Krahn, Victoria (CA)

Correspondence Address: David A. Novais;Patent Legal Staff, Eastman Kodak Company, 343 State Street, Rochester, NY, 14650-2201, US

(21) Appl. No.: 11/678,250

(22) Filed: Feb. 23, 2007

(51) Int. Cl. G06F 17/30

(52) U.S. Cl. 705/27

(57) ABSTRACT

The invention relates to systems and methods for creating a pricing model to be used when ordering printed materials online. In particular, the invention automatically creates a pricing spreadsheet when orderable printed product type information is configured. Thereafter, a user can edit the spreadsheet to create a modified pricing spreadsheet to meet more specific and/or complex needs.

### CROSS REFERENCE TO RELATED APPLICATION

Reference is made to commonly-assigned copending U.S. patent application Ser. No. ______ (attorney docket 93478), filed ______ , entitled A METHOD AND APPARATUS FOR PROCESSING A PRINT ORDER, by Kauffman, the disclosure of which is incorporated herein.

### FIELD OF THE INVENTION

This invention relates to calculating prices for online print orders, and in particular to calculating those prices using electronic spreadsheets.

### BACKGROUND OF THE INVENTION

Pricing models are known in the art to facilitate calculation of a price for items to be produced. Pricing models for non-trivial production processes typically involve the use of pricing parameters which, when input can be used to produce a price estimate. Parametric formulas based on the pricing parameters and on pricing factors, such as labor rates, material costs, opportunity costs, margins and the like, have been used to quickly produce a price estimate.

Ordering printed material can involve complex pricing calculations. This occurs because the number of combinations of pricing parameters and factors can be very large. Pricing parameters can be derived from information specified by a print buyer, such as printing intent and content. Pricing parameters can also be derived from information related to the printing firm's operation, such as resource availability, existing orders, and externally determined costs as examples.

Historically, pricing of printed material was performed manually by a customer service representative (CSR) based on business rules, information derived from a print buyer's order and a CSR's knowledge. Some printing firms and printing system vendors have developed systems to automate price calculations. For example, published US patent application No. 2003/0187808, entitled “Electronic Cost Estimator for Processing of Paper Products”, teaches creating a server based system that calculates costs and markups for a product type based on input received from a print buyer in view of predefined cost/markup information and predefined formulas or algorithms. However, in a system like this, significant time and/or expertise can be required to adapt to changing requirements for pricing (e.g. new product types, new pricing factors).

Some conventional printing systems offer pricing models that have some customization capabilities available to an end user. For example, a price formula can be configured by a user selecting a formula from a predefined set and associating parameters (e.g. pricing parameters and/or pricing factors) with the formula. However, these systems may not have sufficient flexibility to accommodate a full range of pricing models required by a printing firm.

Some conventional systems teach the use of spreadsheets as a means for producing flexible pricing models. For example, published US patent application No. 2005/0257132, entitled “End user customizable computer spreadsheet application based expert system” teaches an expert system that unifies a series of end-user created spreadsheets to account for various product types and production plan/resource options. However, in these systems the onus is on a user to create spreadsheets to support new or modified orderable product types. Further, the system of U.S. patent application No. 2005/0257132 can involve a degree of complexity (e.g. several spreadsheet components embodying production plans and resources) that is not always required.

### SUMMARY OF THE INVENTION

The present invention provides for an electronic print ordering system with the capability to automatically create a first pricing spreadsheet based on information configured by the system for an orderable printed product type. Thereafter, any print orders received for that product type can be automatically priced based on supplying inputs, including at least pricing parameters derived from the print order, to the pricing spreadsheet.

According to an embodiment of the invention, a first pricing spreadsheet can be automatically created when a product type is configured. A set of pricing parameters can be selected from a set of printing parameters for the product type. Spreadsheet cells can be identified for the pricing parameters as well as one or more pricing factors associated with the product type and/or the pricing parameters. Finally at least one cell for a price can be identified whose value is calculated by a formula based on one or more of the pricing parameter and pricing factor cells.

The automatically created first pricing spreadsheet may be adequate for many orderable product types. For product types having more complex pricing requirements, an end user can modify the first pricing spreadsheet according to specific business requirements. This can include modifying the spreadsheet on the user's client computer using a standard spreadsheet editor. This can include creating links to other sources of input such as other spreadsheets, databases or systems. This can also include creating more complex pricing formulas and pricing factors than those automatically created by the printing system. The first pricing spreadsheet at least provides a good starting point for a more complex pricing spreadsheet by providing a spreadsheet with an organizational structure that is compatible with inputs supplied from the automated electronic print ordering system.

According to an embodiment of the invention, printing parameters can be configured with value restrictions (e.g. a list of allowable values for a printing parameter) and these value restrictions can be incorporated into the first spreadsheet to further improve the capability and flexibility of the spreadsheet. For example, pricing factor cells can be automatically identified for allowable values for a printing parameter.

### BRIEF DESCRIPTION OF THE DRAWINGS

FIG. 1 is a system block diagram of a printing system according to an embodiment of the invention;

FIGS. 2A-2B are illustrations of exemplary user interfaces for configuring an orderable printed product type according to an embodiment of the invention;

FIG. 3 is an illustration of an exemplary user interface for ordering printed material based on a printed product type according to an embodiment of the invention;

FIG. 4A is an illustration of an exemplary pricing spreadsheet version created automatically for an orderable printed product type according to an embodiment of the invention; and

FIG. 4B is an illustration of an exemplary modified pricing spreadsheet version according to an embodiment of the invention.

### DETAILED DESCRIPTION OF THE INVENTION

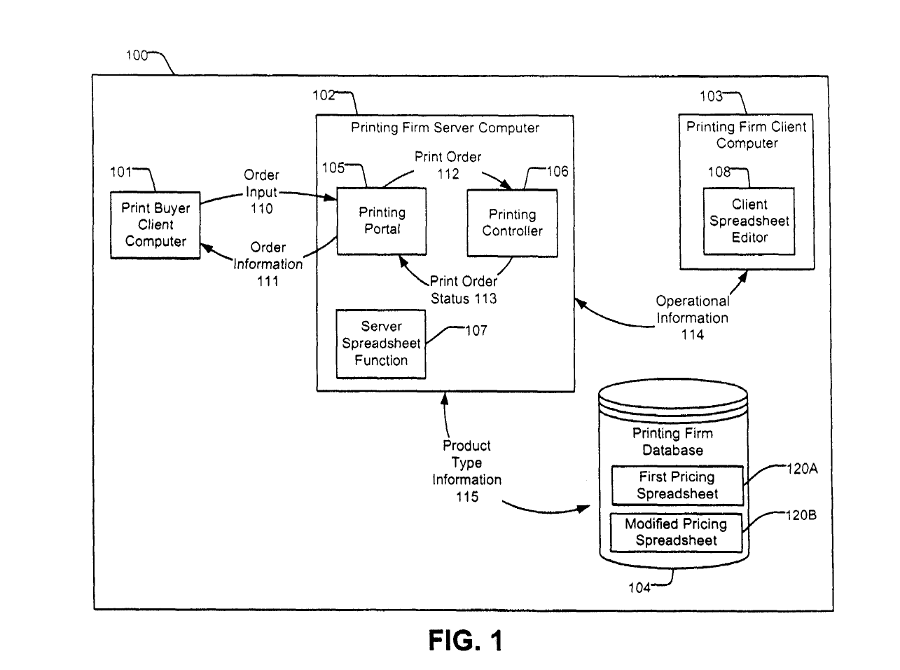

FIG. 1 is a system block diagram of a printing system 100 according to an embodiment of the invention. Printing system 100 can be provided, at least in part, by a printing firm to allow a print buyer to procure printed material from the printing firm by submitting an electronic print order 112 from a client computer 101. The print buyer creates an electronic print order 112 by supplying order input 110 including, for example, information about printing intent and printing content. The print buyer can receive order information 111 including, for example, information about orderable product types, prompts, previews, price estimates and progress information. System 100 can be configured to support a variety of printed product types such as business cards, forms, flyers and the like.

For a given product type, the printing firm can configure information including a number of printing intent parameters whose values are to be supplied by a print buyer. A printing intent parameter can be configured to allow a print buyer to pick from a number of predefined values or can allow the print buyer to supply free-form information (e.g. quantity). Certain parameters (e.g. printing colors) can be configured to be optional and/or have corresponding default values (e.g. CMYK). Optional parameters and their default values may or may not be presented to the user depending on product type configuration.

System 100 also includes equipment at the printing firm's site, including at least one each of a server computer 102, a client computer 103, and a database 104. Multiple occurrences of a piece of equipment can be configured to share processing load or provide continued operation in the event of equipment failure. Equipment of system 100 can be configured to communicate via various means including dedicated connections, network communication services, and wireless communication links as examples.

Server computer 102 provides an environment to operate printing portal 105, printing controller 106, and server spreadsheet function 107. Printing portal 105 can include one or more specialized applications to enable a print buyer to communicate about print orders 112 being processed by system 100. Printing portal 105 submits print order 112 to printing controller 106 and receives print order status 113 which can be communicated back to the print buyer. Printing controller 106 can include one or more specialized applications to provide printing workflow (e.g. prepress operations and printing device management). Other print production software applications (not shown) for supporting other aspects of print production (e.g. finishing, billing, delivery) can also operate on server computer 102 or other computers in communication with server computer 102.

Client computers 101 and 103 can be of similar or different types. Client computer 101 provides an environment to operate a web browser or a specialized application, for example, for communicating with server computer 102 about print orders 112. Client computer 103 provides an environment to operate a web browser or specialized application, for example, for communicating operational information 114 with server 102. Operational information 114 can include, for example, information related to the configuration of and/or the operation of system 100.

Server spreadsheet function 107 can work in conjunction with printing portal 105 to create a first pricing spreadsheet 120A as part of the creation of product type information 115. Server spreadsheet function 107 can be designed to perform typical spreadsheet functions such as create, edit, view, external data access, and calculations under the control of printing portal 105 or another application. Server spreadsheet function 107 is exemplified by the product “SpreadsheetGear for .NET”, supplied by SpreadsheetGear LLC of Lenexa Kans. In particular, server spreadsheet function 107, under the control of printing portal 105, can produce and store first pricing spreadsheet 120A in database 104 for a specific product type when that product type is first configured. Modifications to other product type information 115 that affect pricing (e.g. modifying printing intent parameters) can include modifications to first pricing spreadsheet 120A or creation of a new pricing spreadsheet 120B from first pricing spreadsheet 120A or another version derived from first pricing spreadsheet 120A.

First pricing spreadsheet 120A can be, for example, a basic pricing spreadsheet with at least one formula for calculating at least one price (e.g. the final price). Alternatively, multiple formulas can exist that, for example, calculate prices for each component of the order. A formula can be based on pricing parameters, with values that tend to vary according to the print order, and pricing factors, with values that tend not to vary according to the print order. For example, pricing parameters can include parameters selected from the printing intent parameters specified by the print buyer in a print order. As another example, pricing parameters can include parameters derived from printing content (e.g. number of spot colors). Pricing factors, for example, can include base and/or incremental cost factors (e.g. minimum price per order, incremental cost per-page or per-unit produced).

Selecting pricing parameters from printing intent or other parameters can occur automatically based on input from a user. For example, all printing intent parameters can be selected as pricing parameters, even if they are not all used. As another example, when a user configures a printing intent parameter independent of a product type, a flag can be configured to determine whether it is automatically included as a pricing parameter. As another alternative, a user, configuring printing intent parameters for a product type, can identify which intent parameters should be automatically included as pricing parameters. Similarly, pricing parameters derived from other sources (e.g. content, external sources) can be automatically selected based on predefined information.

Client spreadsheet editor 108 enables a printing firm user to modify an existing version of a pricing spreadsheet (e.g. first pricing spreadsheet 120A). Modifications can include, for example, supplying values for pricing factors defined by the previous version or adding other information into the previous version. Modifications can also include, for example, modifying pricing formulas to include additional pricing factors and/or additional pricing parameters (e.g. based on production characteristics internal to the printing firm). Modifications can also include, for example, providing access (e.g. copy or link) to external sources (e.g. files, databases, and systems) of information to be used in calculating a price. Client spreadsheet editor 108 is exemplified by the product Microsoft® Excel®. Allowing a printing firm user to utilize a familiar spreadsheet editor simplifies the user's task of creating an appropriate pricing model while providing virtually unlimited flexibility for the pricing model.

In one alternate embodiment, printing portal 105 can provide information about selected pricing parameters and/or pricing factors as information to be adapted for use in a spreadsheet. For example, a file can be produced by printing portal 105 including information related to the configuration of the orderable printed product type. The file can be easily imported, if suitably formatted, into pricing spreadsheet 120A by client spreadsheet editor 108. This can be preferable, for example, if a pricing spreadsheet template exists which needs adaptation based on information to be derived from print order 112. The file could be, for example, a spreadsheet file with only pricing parameter and/or pricing factor information included. Alternatively, the file could be a text file, XML file or other type of file.

Various means can be employed to capture versions of a spreadsheet. For clarity, the remainder of the document will assume that each modification, for a product type, generates a new instance of modified pricing spreadsheet 120B. Whether spreadsheet 120A is modified by client spreadsheet editor 108 or server spreadsheet editor 107, modified spreadsheet 120B can be stored in database 104 or other storage facility accessible by computers 102 and 103. Server spreadsheet editor 107 may modify spreadsheet 120A, for example, if a user reconfigures printing intent parameters in product type information 115.

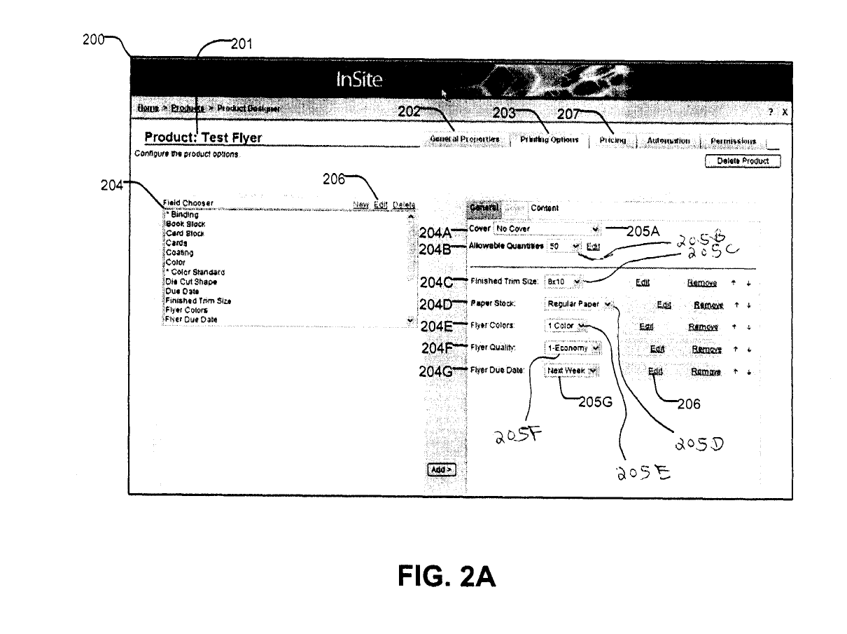

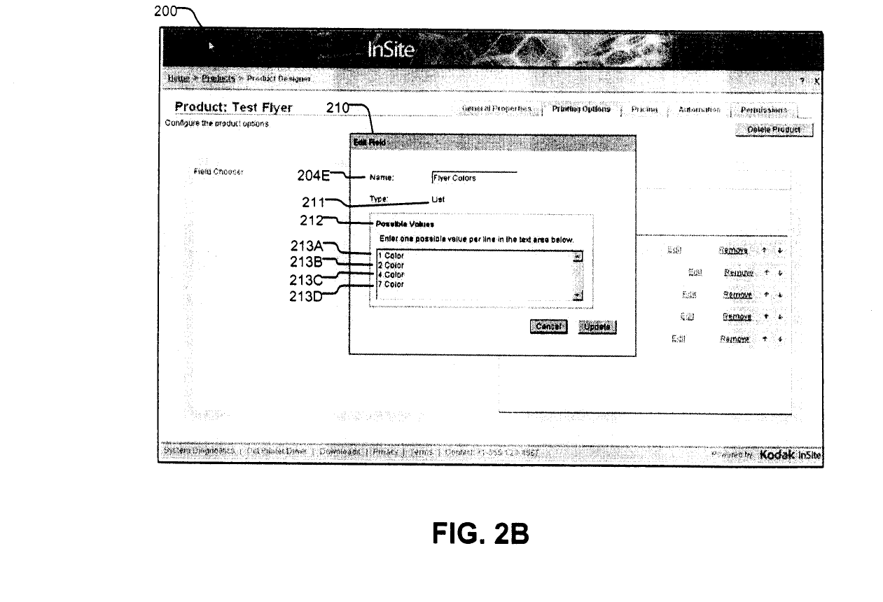

FIGS. 2A-2B are illustrations of exemplary user interfaces for configuring an orderable printed product type according to one embodiment of the invention. FIG. 2A illustrates an exemplary interactive web-browser-based product type configuration display 200. Display 200 can be intended for use by a printing firm administrator to create and/or modify orderable printed product types. Display 200 depicts product type value 201 corresponding to an exemplary “Test Flyer” product type being configured. Product type value 201 was identified when editing General Properties tab 202.

Display 200 also includes printing options tab 203 including a list of available printing intent parameter names 204 that can be chosen from the left side of tab 203. On the right side of tab 203 a set of parameter names 204A-204G have already been added for the product type. Default printing intent parameter values 205A-205G are depicted adjacent the chosen parameter names 204A-204G. For example, default value 205G, (“Next Week”) has been configured for parameter name 204G (“Flyer Due Date”). Printing intent parameter edit controls 206 are also depicted in tab 203 to enable a user to edit a printing intent parameter.

Pricing model tab 207 can present a view of pricing spreadsheet 120A. Tab 207 can, for example, facilitate review of spreadsheet 120 and/or enable launching of client spreadsheet editor 108.

FIG. 2B illustrates an exemplary interactive web-browser-based parameter edit display 210 for editing information associated with printing intent parameter name 204E. Display 210 includes information about parameter name 204E and restricting its possible values. For example, data type field 211 illustrates that parameter name 204E can only include certain values. Parameter value restrictions 212, in this example, includes a list of allowed values 213A-213D. For other data types (e.g. numeric) different value restrictions 212 can be defined (e.g. minimum values, value ranges, and significant figures). Value restrictions 212 can be advantageously used in first pricing spreadsheet 120A as a determinant for pricing factors, as described and illustrated below.

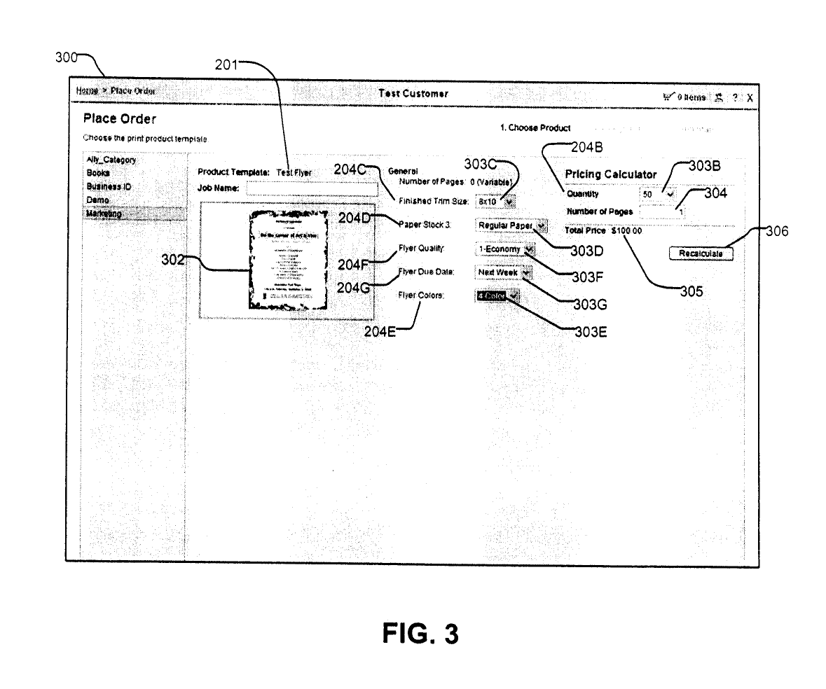

FIG. 3 is an illustration of an exemplary user interface for ordering printed material based on a printed product type according to one embodiment of the invention. FIG. 3 depicts an exemplary interactive web-browser-based print order display 300. Display 300 can be used by a print buyer to provide order input 10 and display order information 111 as described with reference to FIG. 1. Display 300 can include information that changes as ordering steps are completed. As shown, display 300 includes information for a first step corresponding to choosing a product type and specifying related information.

Display 300 depicts that the print buyer has already provided both printing intent and printing content for the print order. In particular product type value 201 indicates intent to order the “Test Flyer” product type. Page preview image 302 depicts a thumbnail image of the image representing “Test Flyer” product type. After uploading content, preview image 302 can be replaced with a thumbnail of the printing content identified by the print buyer. In this example, the printing content includes a single page flyer provided as an Adobe® PDF file. The print buyer has also identified printing intent values 303C-303E for printing intent parameter names 204C-204E (e.g. no change in default printing intent value 205G (“Next Week”)). Additionally, other print order value 304 is displayed, corresponding to a submitted page count parameter, which has been automatically determined by printing portal 105 by examining the printing content. Price estimate 305 is also depicted in display 300 and can be automatically calculated when values 303C-303E, 304, and other values, that may not be included in display 300, are changed. Alternatively, price estimate 305 can be updated by pressing recalculate button 306.

Price estimate 305 can be calculated based on first pricing spreadsheet 120A currently associated with the “Test Flyer” product type. Printing portal 105, for example, can provide server spreadsheet function 107 with values 303C-303E, 304 and other values (e.g. production process values) as inputs to be inserted into appropriate elements of first pricing spreadsheet 120A as discussed below. Server spreadsheet function 107 then executes instructions to perform spreadsheet formula calculations and provides the result to printing portal 105. Portal 105 then displays price estimate 305 based on the result provided by server spreadsheet function 107.

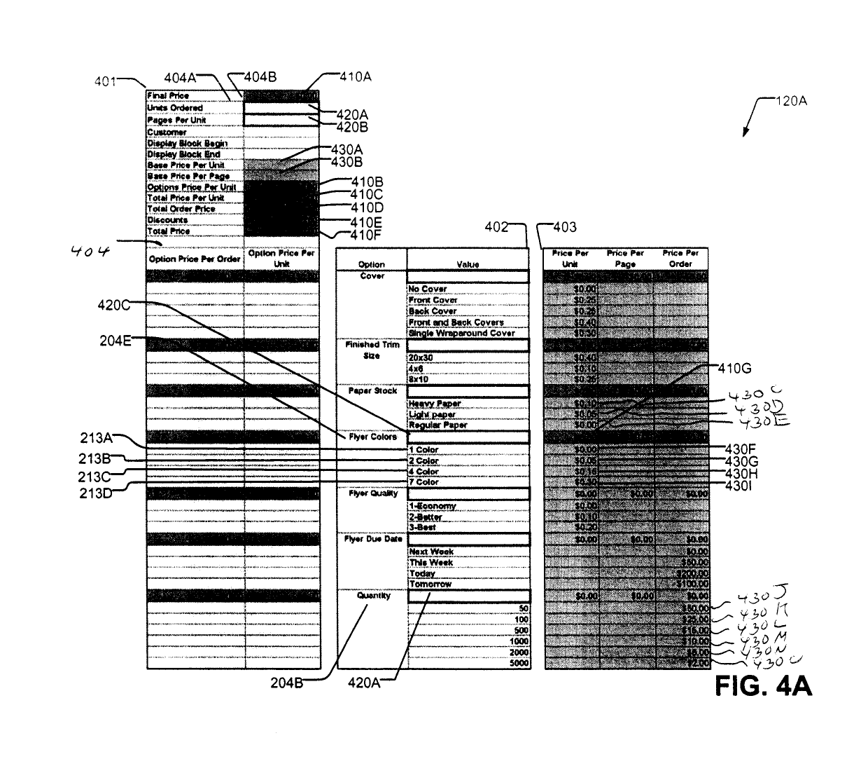

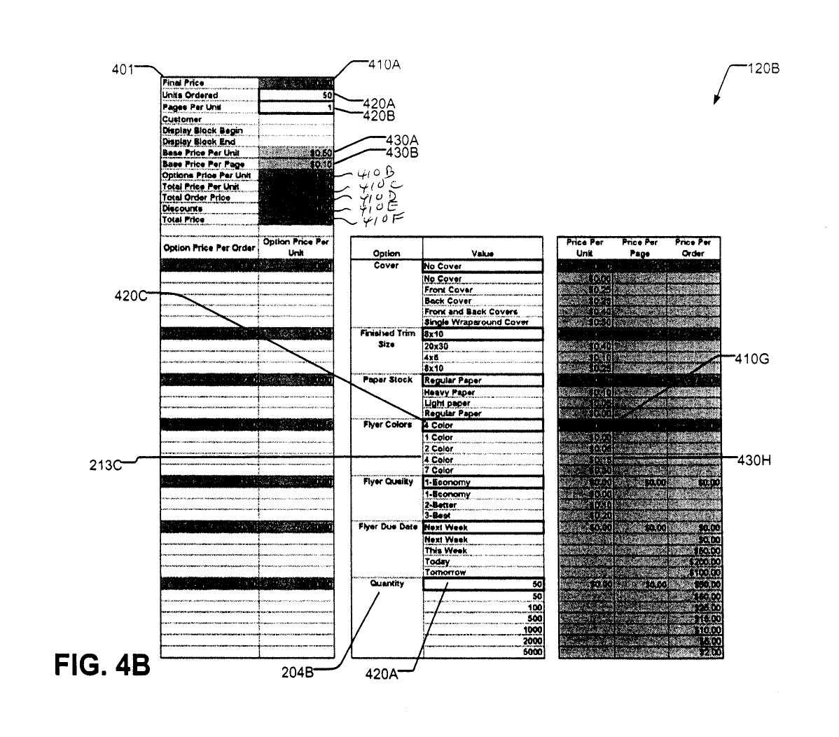

FIG. 4A is an illustration of an exemplary first pricing spreadsheet version 120A, created automatically for the “Test Flyer” product type according to one embodiment of the invention. Spreadsheet version 120A includes three blocks 401-403. Each block 401-403 includes cells demarcated by borders 404, illustrated as dotted lines and exemplified by row border 404A and column border 404B. Cells in block 401 include, for example, general information for a “Test Flyer” order, such as final price, customer information, and discounts. Cells in block 402 include, for example, information about option pricing parameters for a “Test Flyer” order. Cells in block 403 include, for example, information about option pricing factors for a “Test Flyer” order.

Prices 410A-410F are depicted as cells with a dark background, exemplified by final price 410A in block 401. Prices can be associated with formulas, either as part of the spreadsheet cell definition or separately in association with a cell identifier. In first spreadsheet 120A, final price 410A is equated with total price 410F which in turn is a summation of total order price 410D and discounts 410E. Total order price 410D is calculated from (base and option) pricing parameters 420A, 420B, 420C and pricing factors, for example, 430A-430B. Discounts 410E, for example, can be supplied manually when configuring the “Test Flyer” product type, calculated based on the other information from first spreadsheet 120A (e.g. units ordered 420A) or from externally accessible information (e.g. per-customer discount database). Appendix A (located at the end of this specification) includes computer readable information for an exemplary pricing spreadsheet 120A editable by Microsoft® Excel® which details exemplary formulas for each price 410.

Pricing parameters 420A-420C are depicted as cells with a white background and a two-line border, exemplified by units ordered 420A in block 401. Pricing parameters 420A-420C include values derived from print order 112. For example, the value for pricing parameter 420A is derived from printing intent value 303B, both of which are associated with the parameter name 204B having the value “Quantity”. Similarly, the value for the pricing parameter 420C is derived from printing intent value 303E, both similarly associated with parameter name 204E having the value “Flyer Colors”. Other pricing parameters 420A-420C can have their values derived from printing content. For example, the value for pricing parameter 420B is derived from other print order value 304 corresponding to the number of pages printed per unit.

Pricing factors 430A-430O are depicted as cells with a light colored background, exemplified by base price per unit 430A. Spreadsheet 120A includes several factor categories to provide a nominal level of flexibility. These categories include: per-unit, per-page, and per-order. Block 403, for example, provides for specification of pricing factors for each factor category. However, as illustrated in block 403, pricing factors 430A-430O have only been specified in one of each category for associated options identified in block 402. For example, per-unit pricing factors 430F-430I have been created for “Flyer Colors” parameter name 204E while per-order pricing factors 430J-430O have been created for “Quantity” parameter name 204B. It is understood that other pricing factor categories could be defined which could apply to these or other pricing parameters.

As a more detailed example of the use of per-unit pricing factor category, pricing factors 430F-430I have been created in association with allowable values 213A-213D, respectively. They are associated by sharing rows. Allowable values 213A-213D are in turn associated with parameter name 204E having the value of “Flyer Colors” (sharing rows) and pricing parameter 420C (sharing column). In first pricing spreadsheet 120A, for example, these associations allow the value derived for pricing parameter 420C to affect price 410G, corresponding to the per-unit price for the “Flyer Colors” option specified by the print buyer. Price 410G is automatically calculated, by a formula for example, to be one of pricing factors 430F-430I based on which of allowable values 213A-213D is derived for pricing parameter 420C.

Values for pricing factors 430A-430O can be predefined in association with parameter names 204, for example, and obtained by printing portal 105 when automatically creating first pricing spreadsheet 120A. As another alternative, printing portal 105 can prompt a user to supply pricing factors 430A-430O when configuring a product type. Or, as another alternative, a hybrid approach of allowing a user to override predefined pricing factors 430A-430O when configuring a product type. Ultimately, a printing firm user may prefer to modify initially determined pricing factors 430A-430O using spreadsheet editor 108 with the context of the other pricing information presented in a more convenient fashion.

FIG. 4B is an illustration of a modified pricing spreadsheet 120B according to one embodiment of the invention. Modified pricing spreadsheet 120B has been edited by a printing firm user with spreadsheet editor 108 to add values for pricing factors 430A and 430B. Other edits could have been made, for example, including addition, deletion or modification of prices, formulas, pricing parameters, pricing factors and associations with external data.

FIG. 4B also illustrates the effect of printing portal 105 using information from print order 112 to calculate prices 410A-410F. For example, pricing parameters 420A and 420C have been determined from printing intent values 303B (e.g. quantity of “50”) and 303E (e.g. “4 Color” option), respectively. Server spreadsheet function 107, under control of printing portal 105, accessed modified pricing spreadsheet 120B to supply values 420A-420C and obtain value from price 410A as a result of applying the formulas associated with prices 410A-410F. Server spreadsheet function 107 does not need to save a separate modified spreadsheet version 120B as depicted. Rather, spreadsheet version 120B can be maintained with default values (e.g. null values) for pricing parameters 420A-420C and create temporary copies of spreadsheet which include input values for pricing parameters 420A-420C and calculated values for prices 410A-410F.

However, in some embodiments, it may be desirable for printing portal 105 or server spreadsheet function 107 to save copies for historical reference and/or subsequent pricing adjustments based on the actual production activities. For example, a printing firm may allow a print buyer to make modifications to an order after order submission. Keeping the pricing spreadsheet may simplify the calculation of adjustments based on the modifications.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the spirit and scope of the invention.

1. An apparatus for pricing a print order, the apparatus comprising:
a database operative to:
store product type information including, for each product type, a plurality of printing parameters and at least one version of a pricing model;
a server computer operative to:
configure a plurality of printing parameters as part of product type information based on operational information from a client computer;
select a pricing parameter from the plurality of printing parameters configured for a product type;
create a version of a pricing model as part of product type information based on the pricing parameter;
create a print order based on order input for a product type from a client computer;
provide order information to a client computer, wherein the order information includes a price estimate based on the print order and the pricing model retrieved from the database; and
control the production of printed material based on the print order and the product type information obtained from the database; and
a client computer operative to perform one or more of the following:
provide operational information to the server computer;
modify a version of the pricing model and store it in the database;
provide order input to the server, wherein order input includes values for printing parameters configured for a product type; and
receive order information from the server.

2. A method for pricing an orderable printed product type, the method comprising:
configuring a plurality of printing parameters for a printed product type whose values can be determined in response to a print buyer submitting a print order;
automatically creating a pricing model in response to said configuring of the plurality of printing parameters; and
applying the pricing model based on a print order submitted by a print buyer to provide the print buyer with a price estimate for the print order.

3. A method according to claim 2, wherein automatically creating the pricing model comprises:
selecting a pricing parameter from the plurality of printing parameters; and creating a version of a pricing spreadsheet for the printed product type based on the pricing parameter.

4. A method according to claim 3, wherein creating the version of the pricing spreadsheet based on the pricing parameter comprises identifying a pricing parameter cell to hold a value derived from a print order for the corresponding printing parameter.

5. A method according to claim 4, wherein creating the version of the pricing spreadsheet also includes identifying at least one pricing factor cell in association with the pricing parameter cell.

6. A method according to claim 5, wherein creating the version of the pricing spreadsheet also includes identifying a price cell whose value is calculated from a pricing formula based on the pricing parameter cell and the at least one pricing factor cell.

7. A method according to claim 2, wherein configuring the plurality of printing parameters includes configuring a user-defined printing parameter.

8. A method according to claim 2, wherein configuring the plurality of printing parameters includes associating value restrictions for at least one of the plurality of printing parameters to limit allowable input for the at least one printing parameter.

9. A method according to claim 3, wherein configuring the plurality of printing parameters includes associating value restrictions for at least one of the plurality of printing parameters to limit allowable input for the at least one printing parameter.

10. A method according to claim 9, wherein creating the version of the pricing spreadsheet also includes identifying at least one pricing factor cell for an expected value of a pricing parameter, wherein the expected value is based on the value restrictions for the pricing parameter.

11. A method according to claim 6, including modifying the version of the pricing spreadsheet to form a new version of the pricing spreadsheet.

12. A method according to claim 11, wherein modifying the version of the pricing spreadsheet includes automatically modifying in response to reconfiguring printing parameters for the printed product type.

13. A method according to claim 11, wherein modifying the version of the pricing spreadsheet comprises a user modifying the pricing spreadsheet.

14. A method according to claim 11, wherein modifying the version of the pricing spreadsheet comprises modifying the at least one pricing factor cell.

15. A method according to claim 11, wherein modifying the version of the pricing spreadsheet comprises modifying the pricing formula.

16. A method according to claim 11, wherein modifying the version of the pricing spreadsheet comprises adding information to the pricing spreadsheet to be used in the pricing formula.

17. A method according to claim 16, wherein adding information to the pricing spreadsheet to be used in the pricing formula comprises creating a link to information external to the pricing spreadsheet.

18. A method according to claim 3, including a user modifying the version of the pricing spreadsheet to form a new version of the pricing spreadsheet wherein a software program of a first type is used for automatically creating the version of the spreadsheet and a second program of a second type is used by a user to modify the version of the spreadsheet.

19. A method according to claim 3, wherein creating the version of the pricing spreadsheet includes creating by a server computer.

20. A method according to claim 19, wherein selecting the pricing parameter from the plurality of printing parameters comprises selecting automatically by the server computer.

21. A method according to claim 19, wherein selecting the pricing parameter from the plurality of printing parameters comprises selecting by the server computer based on user input from a client computer.

22. A method according to claim 19, including modifying a version of the pricing spreadsheet, wherein modifying comprises modifying by a client computer based on input from a user.

23. A method for pricing print orders, the method comprising:
automatically producing information to be used in creating a pricing spreadsheet, wherein producing the information is performed at a first computer based on configured printing parameters, and wherein creating the pricing spreadsheet is performed at least in part by a second computer; and
calculating a price for a print order by inputting pricing parameter values derived from the print order to the pricing spreadsheet.

24. A method according to claim 23, wherein the first computer comprises a server computer and the second computer comprises a client computer.
